(19) United States
(12) Patent Application Publication
(10) Pub. No.: US 2002/0104922 A1
(43) Pub. Date: Aug. 8, 2002

(54) Vertical takeoff and landing aircraft with multiple rotors

(76) Inventor: Mikio Nakamura, Ina (JP)

Correspondence Address: Mikio Nakamura, 7200-23 Nishiminowa, Ina, Nagano, 399-4501, JP

(21) Appl. No.: 09/732,096

(22) Filed: Dec. 8, 2000

(51) Int. Cl. B64C 27/52

(52) U.S. Cl. 244/17.25

(57) ABSTRACT

The present invention concerns a vertical takeoff and landing aircraft (VTOL) with multiple rotors which can immediately change pitch angle of each rotor to stabilize body balance when cargo or person is picked up or taken off. VTOL according to the invention comprises

a gear unit (F) and a gear unit (R), said gear unit (F) having two driving gears (6) combined on both sides of another driving gear (5) and variable pitch rotors (FR) and (FL) combined with the other end of said driving gears (6) respectively, and said gear unit (R) having the same driving gear system as said gear unit (F) and variable pitch rotors (RR) and (RL) combined with the other end of said driving gears (6) respectively,

a transmission shaft combined with said gear units (F), (R) and said driving gear (5),

a frame to support all said units, and

a protector equipped outside of said rotors (FR), (FL), (RR) and (RL) with a certain clearance.

### FIELD OF THE INVENTION

The present invention relates to vertical takeoff and landing aircraft (hereafter referred to as VTOL) with multiple rotors having variable pitch angle that is the angle of rotor against the plane perpendicular to the rotor shaft, the multiple rotors being controlled by an engine through a power transmission shaft.

### BACKGROUND OF THE INVENTION

Conventional helicopter usually has one or two rotors on the top of it, each of the rotors controlled by its own engine. If a helicopter has multiple rotors over two, weight of it is multiplied by additional equipment such as engines necessary for each rotors, the weight requiring rotors with wider rotation radius to fly it, resulting in large size body. In a conventional helicopter with one or two rotors, it is also hard to maintain balance if cargo is loaded or unloaded at the position away from the gravity center of the helicopter; in the worst case it would crash.

On the other hand, in order to transmit power from a main transmission shaft to following plural shaft, many bevel gears have been used as shown in FIG. 11, which can also multiply the weight of the helicopter. The functions such as the distance from the main transmission shaft to a following shaft, the direction of a following shaft, rotation direction and speed of each following shaft and the compensation of torque among following shafts require many bevel gears. The bevel gear system also requires additional parts such as bearings to support the gears and shafts to transmit rotation to them. This complicated mechanism causes high costs, much weight, inferior precision on tooling or assembling, to reduce reliability of VTOL.

### SUMMARY OF THE INVENTION

To solve the above problems, the present invention comprises

a gear unit (F) and a gear unit (R), said gear unit (F) having two driving gears (6) combined on both sides of another driving gear (5) and variable pitch rotors (FR) and (FL) combined with the other end of said driving gears (6) respectively, and said gear unit (R) having the same driving gear system as said gear unit (F) and variable pitch rotors (RR) and (RL) combined with the other end of said driving gears (6) respectively,

a transmission shaft combined with said gear units (F), (R) and said driving gear (5),

a frame to support all said units, and

a protector equipped outside of said rotors (FR), (FL), (RR) and (RL) with a certain clearance.

Further the present invention can comprise said frame (2a) bent into a certain angle in the middle and said transmission shaft (1a) connected in the middle with an universal joint.

Using a simple gear mechanism according to the invention, the degree of freedom for attaching direction of driving gear shaft and the degree of freedom for high speed rotation of driving gears are enhanced. The gear system according to the invention is a simple gear mechanism with at least 3 gears compensating torque powers among driving gear shafts with relatively reverse rotation. Thus the quantity of parts and the weight of the aircraft are reduced drastically.

### BRIEF DESCRIPTION OF THE DRAWINGS

The objects and features of the present invention will become more apparent from the consideration of the following detailed description taken in conjunction with the accompanying drawings in which:

FIG. 1 is the plane view of the first embodiment of the invention.

FIG. 2 is the side view of the first embodiment of the invention.

FIG. 3 is the front view of the first embodiment of the invention.

FIG. 4 shows the fundamental combination of gears according to the first embodiment of the invention, wings partially abbreviated for preferable explanation.

FIG. 5 is the plane view of the gear unit according to the first embodiment of the invention, wings being abbreviated partially for preferable explanation.

FIG. 6 is the front view of the gear unit according to the first embodiment of the invention, wings being abbreviated partially for preferable explanation.

FIG. 7 is the side view of the gear unit according to the first embodiment of the invention, wings being abbreviated partially for preferable explanation.

FIG. 8 is the perspective view for brief explanation of the gear unit according to the first embodiment of the invention, wings being abbreviated partially for preferable explanation.

FIG. 9 is the side view of the second embodiment of the invention.

FIG. 10 is the perspective view of the third embodiment of the invention.

FIG. 11 is the perspective view of gear combination according to prior art.

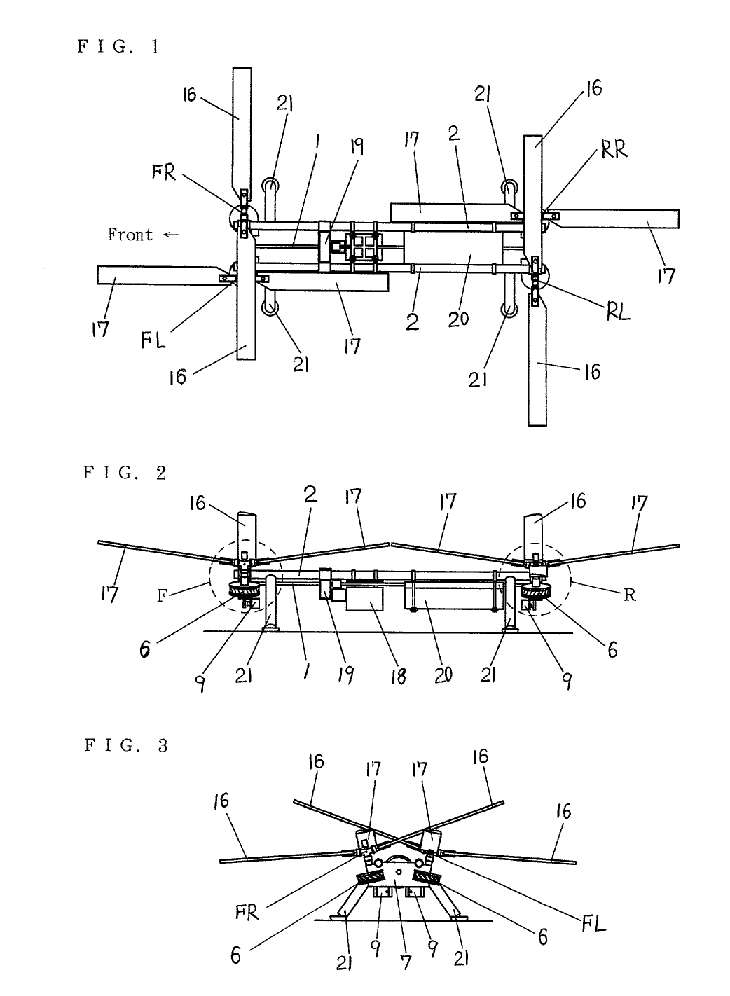

Explanation for the symbols

| F: | Front gear unit, | R: | Rear gear unit |
|---|---|---|---|
| FR: | Front right rotors with | | |
| | variable pitch wings, | | |
| FL: | Front left rotors with | | |
| | variable pitch wings, | | |
| RR: | Rear right rotors with | | |
| | variable pitch wings, | | |
| RL: | Rear left rotors with | | |
| | variable pitch wings, | | |
| 1: | Transmission shaft, | 1a: | Transmission shaft with universal |
| | | | joint, |
| 2: | Frame, | 2a: | Frame bent into a certain angle |
| 3: | Rotor shaft attachment, | 4: | Driving gear shaft holder, |
| 5: | Driving gear, | 6: | Driving gear, |
| 7: | Frame Plate, | 8: | Bearings |
| 9: | Servomotor, | 10: | Servo link |
| 11: | L link, | 12: | Operation rod, |
| 13: | Pitch control head, | 14: | Pitch control link, |
| 15: | Wing holder, | 16: | Right rotor |
| 17: | Left rotor, | 18: | Engine |
| 19: | Reduction gear, | 20: | Electric box, |
| 21: | Leg, | 22: | Servomotor attachment, |
| 23: | Universal joint, | 24: | Cargo loading arm, |
| 25: | Protector, | 26: | Tall building |
| 27: | Window | | |

### DETAILED DESCRIPTION OF THE PREFERRED EMBODIMENTS

Preferred embodiments of the present invention are described below.

### EXAMPLE 1

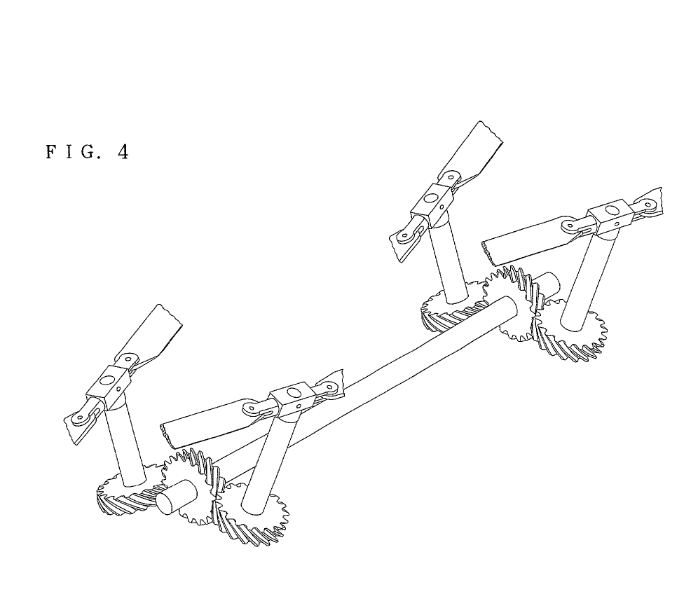

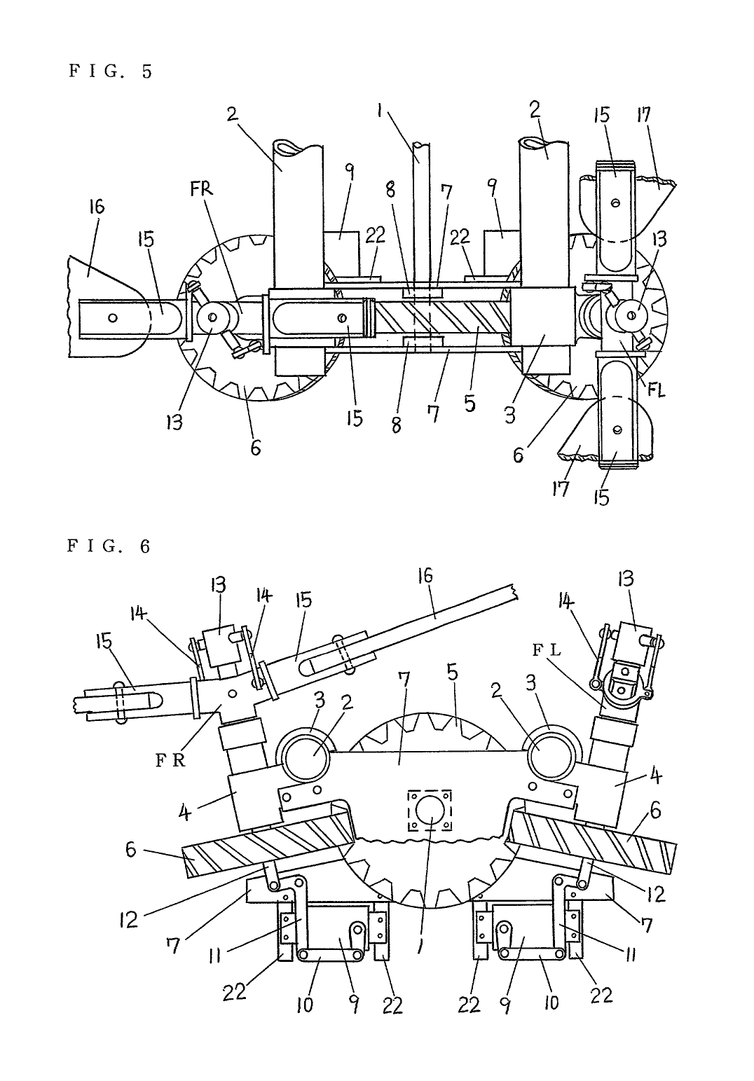

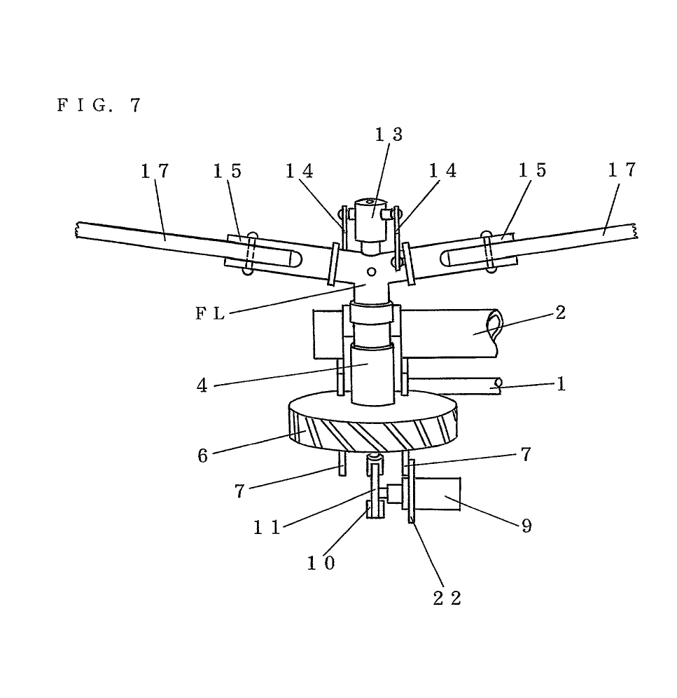

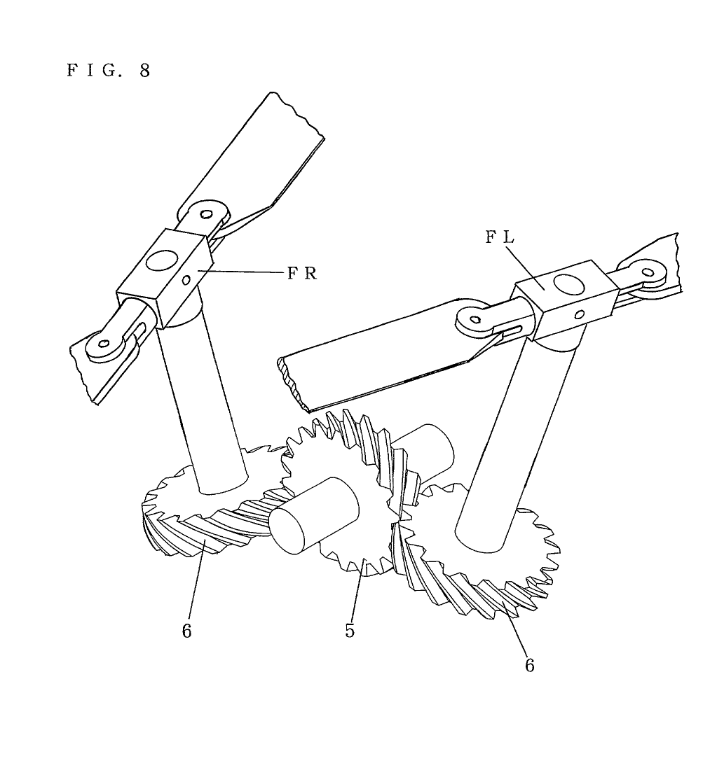

As shown in FIGS. 4, 6 and 8, two driving gears (6) are combined on each side of another driving gear (5) with a certain angle. Variable pitch rotors (FR) and (FL) are combined on the other end of each driving gear (6) and their pitch angle are changed with a servomotor equipped for each rotor. As shown in FIG. 2, gear units (F) and (R) are located in front and rear, and supported by frame (2). Both gear units are combined to transmission shaft (1) through driving gears (5) respectively. An engine (18) installed on frame (2) transmit rotation to said transmission shaft (1) through reduction gear (19). These are the basic construction of VTOL according to the invention, wherein four variable pitch rotors (FR), (FL), (RR) and (RL) are rotated synchronously through a transmission shaft.

The detailed explanation for the example is described below. A driving gear (5) is combined with bearings (8) fixed on two frame plates (7). Each driving gear (6) is combined with said frame plates (7) through gear shaft holder (4) to engage with another driving gear (5) with a certain angle as shown in FIG. 6. Wings (16) or (17) on variable pitch rotors (FR) and (FL) equipped on the other end of said driving gear (6) are crossed not to touch each other. Pitch angle of each wing can be changed with each servomotor (9) installed on said frame plate (7) with servomotor attachment (22) through servo link (10), L link (11), operation rod (12), pitch control head (13), pitch control link (14) and wing holder (15). These are the composition of a gear unit (F) or (R).

Said gear unit (F) and (R) are installed on said frame (2) at the front and the rear as shown in FIG. 2. Driving gears (5) on said gear units (F) and (R) are connected through said transmission shaft (1) which also works to compensate thrust loading generated by driving gears. The direction of teeth on said gear unit (F) is against that on said gear unit (R), thrust loading generated by both gear units drawing said transmission shaft to compensate each other.

An engine (18) is installed on said frame (2) to transmit rotation power to said transmission shaft (1) through reduction gear (19). Said frame (2) also provides with fuel tank, electric box (20) and four legs (21).

To fly the VTOL according to the invention, the power of said engine (18) is raised to rotate said driving gears (5) on said gear units (F) and (R) through reduction gear (19) and said transmission shaft (1). The rotation power is transmitted to four variable pitch rotors (FR), (FL), (RR) and (RL) to generate lift that flies the VTOL. Controlling pitch angle of each rotor at the same time with each servomotor (9) enables climbing up or down, hovering, forwarding or reversing, right or left shift, or turning.

If pitch angle of two front rotors is reduced, lift decreases to lower the top of the VTOL. If pitch angle of two rear rotors is increased, lift increases to raise the tail. When either or both of these operation are performed, the VTOL tilts forward and goes ahead. If the reverse operation is performed, the VTOL tilts backward and goes back. If the same operation is performed for two right rotors and/or two left rotors, the VTOL will go right or left.

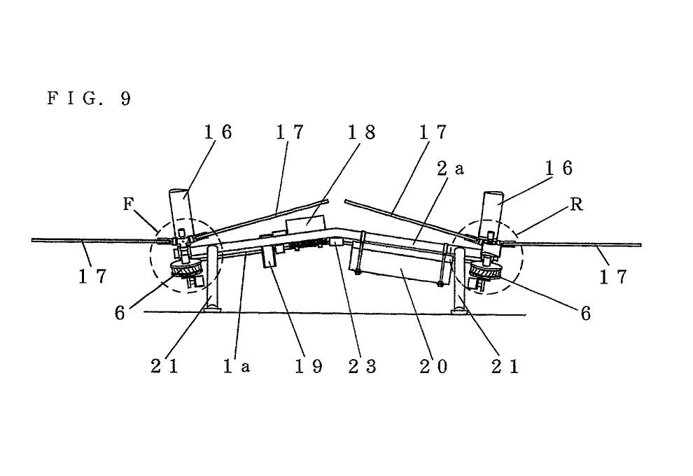

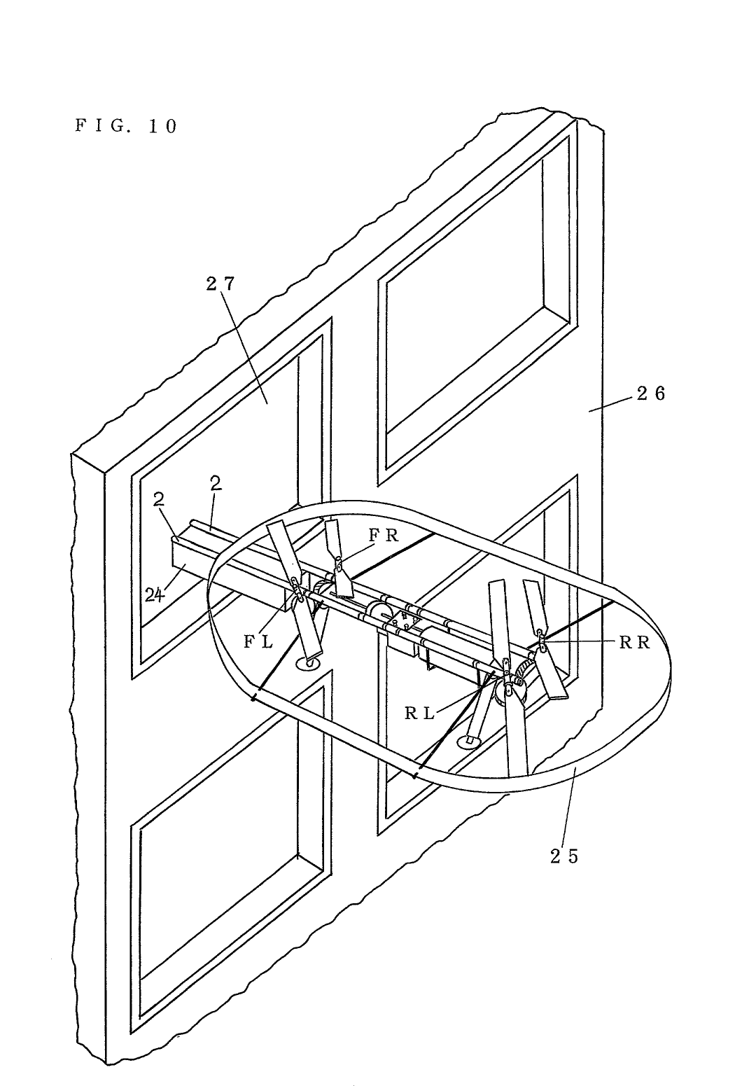

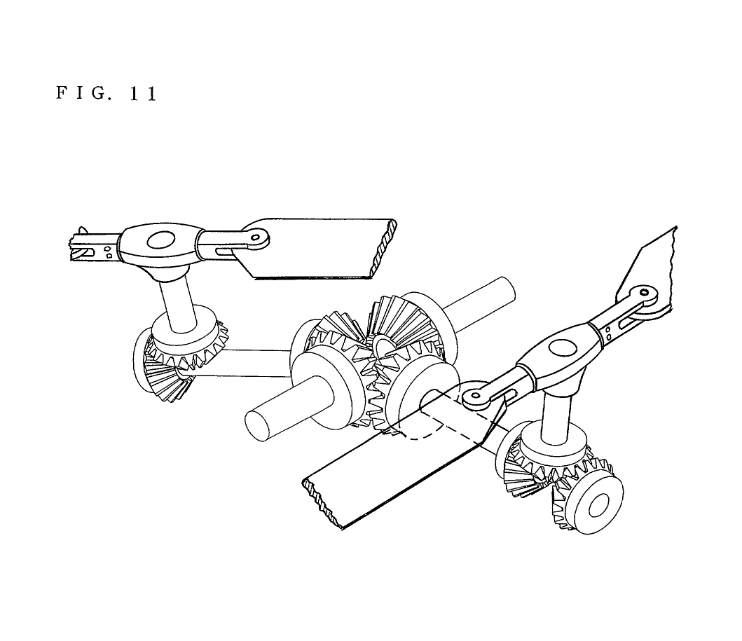

As mentioned above, the only requirement for controlling and flying the VTOL is controlling pitch angle. This simple control enables quick response to abrupt balance shift due to loading or unloading cargo at a position outside of rotor's rotation range shown in FIG. 9 as well as at the gravity center.

### EXAMPLE 2

Gear units (F) and (R) described in Example 1 are installed on the front and the back of frame (2a) bent in a certain angle at the middle as shown in FIG. 9. Thus said gear unit (F) tilts forward as well as variable pitch rotors (FR) and (FL), while said gear unit (R) tilts backward as well as variable pitch rotors (RR) and (RL). In each of said gear units (F) and (R), each rotor is installed tilted outward; two right rotors (FR) and (RR) into right and two left rotors (FL) and (RL) into left.

Because of the angle of said frame (2a), universal joint (23) is put on transmission shaft (1a) in the middle. Said frame (2a) is also equipped with engine (18) to transmit power to transmission shaft with joint (23) through reduction gear (19) as well as fuel tank, electric box (20) and four legs (21).

To fly the VTOL according to Example 2, the power of said engine (18) is raised to rotate said driving gears (5) on said gear units (F) and (R) through reduction gear (19) and said transmission shaft (1a) with universal joint (23). The rotation power is transmitted to four variable pitch rotors (FR), (FL), (RR) and (RL) at the same time to generate lift that flies the VTOL. Controlling pitch angle of each rotor at the same time with each servomotor (9) enables climbing up or down, hovering, forwarding or reversing, right or left shift, or turning without body tilt.

If pitch angle of two front rotors is reduced, lift decreases to lower the top of the VTOL. If pitch angle of two rear rotors is increased, lift increases to raise the tail. When either or both of these operation are performed, the VTOL goes ahead. If the reverse operation is performed, the VTOL goes back. If the same operation is performed for two right rotors and/or two left rotors, the VTOL will go right or left.

VTOL according to the invention goes ahead, back right or left without body tilt if pitch angle of each rotor is controlled at the same time.

### EXAMPLE 3

Protector (25) is installed outside of rotation range of each rotor as shown in FIG. 10 to prevent wings from crashing against obstacle. Cargo loading arm (24) is also installed on frame (2) extended ahead of rotation range of front rotors (FR) and (FL).

VTOL according to Example 3 approaches tall building (26) hovering or pulls up alongside a window (27) on said tall building to load or unload cargo with said arm (24) or even to pick up or drop off a person. The VTOL will be very much helpful for fire fighting or rescue on fire of tall building.

When cargo or person is picked up or dropped off from VTOL, body balance shifts instantly to make VTOL unstable. In that case, pitch angle of rotors must be changed immediately. If cargo is unloaded, the top of the VTOL is released from load to climb up, tilting the body backward. At the moment, pitch angle of front rotors (FR) and (FL) are reduced and pitch angle of rear rotors (RR) and (RL) are increased to level the body.

What is claimed:

1. A vertical takeoff and landing aircraft with multiple rotors comprising
a gear unit (F) and a gear unit (R), said gear unit (F) having two driving gears (6) combined on both sides of another driving gear (5) and variable pitch rotors (FR) and (FL) combined with the other end of said driving gears (6) respectively, and said gear unit (R) having the same driving gear system as said gear unit (F) and variable pitch rotors (RR) and (RL) combined with the other end of said driving gears (6) respectively,
a transmission shaft combined with said gear units (F), (R) and said driving gear (5),
a frame to support all said units, and
a protector equipped outside of said rotors (FR), (FL), (RR) and (RL) with a certain clearance.

2. A vertical takeoff and landing aircraft with multiple rotors according to claim 1, wherein said frame (2a) is bent into a certain angle in the middle and said transmission shaft (1a) is connected in the middle with an universal joint.
